(19) United States
(12) Patent Application Publication
(10) Pub. No.: US 2003/0101065 A1
(43) Pub. Date: May 29, 2003

(54) Method and apparatus for maintaining conversation threads in electronic mail

(75) Inventors: Steven L. Rohall, Winchester, MA (US); Seymour Kellerman, Cambridge, MA (US)

Correspondence Address: KUDIRKA & JOBSE, LLP, ONE STATE STREET, SUITE 1510, BOSTON, MA, 02109, US

(73) Assignee: INTERNATIONAL BUSINESS MACHINES CORPORATION

(21) Appl. No.: 09/995,151

(22) Filed: Nov. 27, 2001

(51) Int. Cl. G06F 17/60

(52) U.S. Cl. 705/1

(57) ABSTRACT

A technique for creating and visualizing complete conversation-thread trees in an electronic mail environment includes a mail agent which creates a shadow document upon sending or receiving an original document. The shadow document includes references to a parent or child document(s). Optionally, the shadow document may include references to the root document of a conversation-thread tree, as well as meta data which may include header information, such as sender, receiver, original size, subject, date, carbon copies, etc., and key words from the content of the document or any attachments. An algorithm can be used to recursively traverse the references to the parent of each shadow document, and, once the root of a conversation-thread tree has been identified, to then recursively traverse all references to child documents. In this manner, a tree representing a complete conversation thread may be determined. The data identifying the shadow documents and which form the nodes of the conversation thread tree may be provided to program code which visually renders the conversation thread tree as part of a user interface.

### FIELD OF THE INVENTION

This invention relates, generally, to data processing systems and, more specifically, to a technique for tracking the sequence of electronic mail documents exchanged between users.

### BACKGROUND OF THE INVENTION

Electronic mail has become one of the most widely used business productivity applications. However, people increasingly feel frustrated by their email. They are overwhelmed by the volume, lose important items, and feel pressure to respond quickly. Though electronic mail usage has changed, electronic mail clients have changed little since they were first invented. Although today's electronic mail clients are more graphical with onscreen buttons, pull-down menus and rich-text display, they are essentially derivative programs of the electronic mail clients from thirty years ago. Most electronic mail clients today have the same set of features and organizational structures: multiple folders in which messages can be filed, a textual listing of the messages within a given folder, and the ability to preview a selected message. However, studies have shown that folder systems quickly degrade with the number of messages people receive. Most people end up keeping all of their electronic mail in one large folder. The content and use of electronic mail have also changed. In addition to traditional letters, electronic mail now consists of invitations, receipts, transactions, discussions, conversations, tasks, and newsletters, to name a few variations.

At its simplest, a conversation thread in electronic mail represents the series of replies to a message and the replies to those replies. Each person has a separate representation of a thread of messages in an electronic mail exchange. Some electronic mail systems have support for message threads. Typically, they display a textual representation of the conversation-thread tree using a Windows Explorer-like tree control. Within electronic mail, threads are frequently incomplete. In particular, a user may choose to delete some received messages or not save copies of sent messages. As a result, electronic mail systems that do post-hoc analysis for thread determination (e.g., by using “In-Reply-To” headers) create threads that are incomplete and have holes. For example, Lotus Notes, Rev 5, and thereafter, commercially available from International Business Machines Corporation, Armonk, N.Y., includes a facility termed DiscussionThreadsView which enables a user to visually see Lotus electronic mail messages represented as documents in a visual format. The problem with this functionality is that if a Notes user deletes an electronic mail, a node in the tree is lost and the conversation thread or tree branch may be prematurely terminated.

Accordingly, a need exists for a way to reconstruct conversation threads representing electronic mail document exchanges, even after one or more of the documents in a conversation have been deleted.

A further need exists for a way to reconstruct conversation threads representing electronic mail document exchanges which can be rendered easily to provide a visual model of the conversation thread.

Yet a further need exists for a way to reconstruct conversation threads representing electronic mail document exchanges in a manner which can be efficiently stored in memory.

### SUMMARY OF THE INVENTION

The present invention discloses a technique for maintaining the integrity of conversation threads within an electronic mail environment, even if one or more electronic messages within a conversation thread have been deleted. The invention contemplates the creation of a shadow document from an original document, e.g., an electronic mail message, at certain times within the life of the document. For example, the shadow document may be created at the time of deletion of the original document. Alternatively, the shadow document may be created at the time an electronic message is either received or sent.

The shadow document includes references or pointers to any parent or child documents within a conversation thread, as well as, optionally, a pointer to the root document of a conversation thread tree. The shadow document also includes a reference or link to the original document, if still in existence. Complete conversation thread trees may be constructed and displayed using routines which traverse the chain of links among parent and child documents. Shadow documents may also optionally include “meta” data associated with the electronic mail message. Such meta data may include header information, such as sender, receiver, original document size, subject, date, carbon copies, etc. Optionally, key words or summaries of the document content and/or attachments may likewise be included. The shadow document can be stored within a database.

Given the content of the shadow documents and their relationship to the original documents, an algorithm can be used to recursively traverse the references to the parent of each shadow document, and, once the root of the conversation thread tree has been identified, to then recursively traverse all references to child documents. In this manner, a complete tree representing the conversation thread may be determined. The data identifying the shadow documents which form the nodes of the tree may then be provided to program code which may visually render the tree for the users benefit.

Specifically, a graphics application receives document data representing the tree nodes from the memory and renders the tree graphically. Nodes may be rendered with different graphic elements such as color to define relationships. By selecting one of the nodes in a displayed conversation thread tree the user can, in one embodiment, cause a low resolution display of that document, either the original or the shadow document, to be displayed within the context of the tree. Other additional concepts relating to visual presentation of the tree includes superimposing of the tree with a time line, as well as presenting a microview of the tree showing all the nodes.

The data from all shadow documents within a conversation thread may be stored in a single document within a database, instead of multiple documents. In this embodiment, a single shadow document will include all of the linking and meta data of the individual nodes within the tree. According to one aspect of the invention, in a computer system operatively coupled to a network and capable of executing a communication process for sending and receiving original electronic documents, a method comprises: (A) creating a shadow document from an original document; (B) identifying one of a parent and child document of the original document and storing a reference thereto in the shadow document; and (C) storing the shadow document in memory. The creation of a shadow document from an original document may occur upon the occurrence of a predetermined event which may be any of the sending, receiving or deletion of the original documents. In one embodiment creation of a shadow document further comprises parsing the original document for selected logistical data including any of the sender, receiver, original document size, subject, date, carbon copies of the original document. In another embodiment creation of a shadow document further comprises filtering the original document for selected content. In yet another embodiment the method further comprises resolving the reference in a shadow document to one of the parent and child document, maintaining in memory data identifying a plurality of shadow documents and any parent and child documents thereof, and presenting the organized plurality of shadow documents with graphics representations in a parallel tree arrangement in chronological order.

According to a second aspect of the invention, a computer program product and computer data signal for use with a computer system operatively coupled to a network and capable of executing a communication process for sending and receiving original electronic documents, comprises (A) program code for creating a shadow document from an original; (B) program code for identifying one of a parent and child document of the original document and storing a reference thereto in the shadow document; and (C) program code for storing the shadow document in memory.

According to a third aspect of the invention, an apparatus for use with a computer system operatively coupled to a network and capable of executing a communication process for sending and receiving original electronic documents, comprises (A) program logic for creating a shadow document from an original document; (B) program logic for identifying one of a parent and child document of the original document and storing a reference thereto in the shadow document; and (C) program logic for storing the shadow document in memory.

According to a fourth aspect of the invention, in a computer system operatively coupled to a network and capable of executing a communication process for sending and receiving original electronic documents, a method comprises: (A) creating a shadow document from an original document upon sending of the original document by the communication process; (B) identifying one of a parent and child document of the sent original document and storing a reference thereto in the shadow document; (C) creating a shadow document from an original document received from another communication process; (D) identifying one of a parent and child document of the received original document and storing a reference thereto in the shadow document; and (E) storing the shadow documents in memory. In another embodiment, the method further comprises (F) resolving the reference in a shadow document to one of the parent and child document; and (G) maintaining data identifying a plurality of shadow documents and any references to any parent and child documents thereof. In yet another embodiment the method further comprises (H) presenting graphical representations of a plurality of documents in a manner which indicates relationships among the documents.

### BRIEF DESCRIPTION OF THE DRAWINGS

The above and further advantages of the invention may be better understood by referring to the following description in conjunction with the accompanying drawings in which:

FIG. 1 is a block diagram of a computer systems suitable for use with the present invention;

FIG. 2 is a conceptual illustration of the relationship between the components of the system in which the present invention may be utilized;

FIG. 3 is a conceptual illustration of a computer network environment in which the present invention may be utilized;

FIG. 4 is a conceptual illustration of a data structure in accordance with the present invention;

FIGS. 5A-B form a flow chart illustrating the process steps performed by the present invention;

FIGS. 6A-D are conceptual illustrations of a conversation-thread trees in accordance with the present invention;

FIG. 7 is a conceptual illustration of an alternative conversation-thread tree superimposed with a time-line; and

FIG. 8 is a conceptual illustration of a micro view of a document as part of a conversation-thread tree in accordance with the present invention.

### DETAILED DESCRIPTION

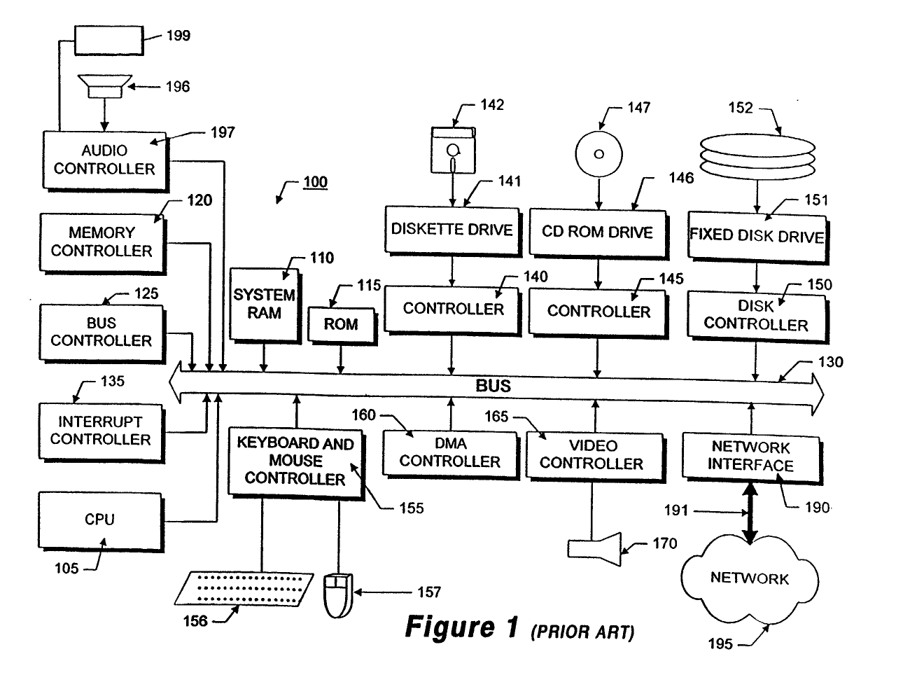

FIG. 1 illustrates the system architecture for a computer system 100, such as an IBM PS/2® computer on which the invention can be implemented. The exemplary computer system of FIG. 1 is for descriptive purposes only. Although the description below may refer to terms commonly used in describing particular computer systems, such as an IBM PS/2 computer, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146 which is connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic use interface presented thereon by an application or the operating system, in addition to or in combination with any keyboard, pointing device, joystick, voice recognition system, speakers, microphone or any other mechanism through which the user may interact with the computer system. Computer system 100 also includes a communications adapter 190 which allows the system to be interconnected to a local area network (LAN) or a wide area network (WAN), schematically illustrated by bus 191 and network 195.

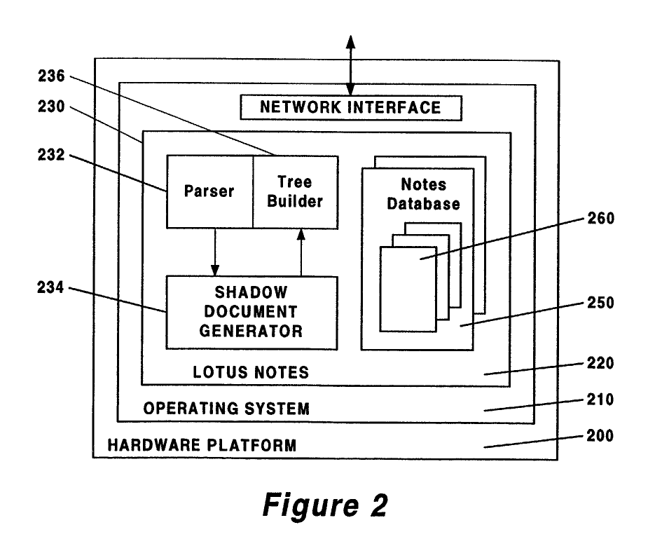

Computer system 100 is generally controlled and coordinated by operating system software, such the OS/2® operating system, available from International Business Machines Corporation, Armonk, N.Y., or Windows® operating system, available from Microsoft Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including AIX, UNIX and LINUX, DOS, etc. The relationship among hardware, operating systems, and user applications is shown in FIG. 2. One or more applications 220 such as Lotus Notes or Lotus Sametime, both commercially available from International Business Machines Corporation, Armonk, N.Y., may execute under control of the operating system. If operating system 210 is a true multitasking operating system, multiple applications may execute simultaneously.

In the illustrative embodiment, the present invention may be implemented using object-oriented technology and an operating system which supports execution of object-oriented programs. For example, the inventive code module may be implemented using the C++ language or as well as other object-oriented standards, including the COM specification and OLE 2.0 specification for Microsoft Corporation, Redmond, Wash., or, the Java programming environment from Sun Microsystems, Redwood, Calif.

In the illustrative embodiment, the elements of the system are implemented in the C++ programming language using object-oriented programming techniques. C++ is a compiled language, that is, programs are written in a human-readable script and this script is then provided to another program called a compiler which generates a machine-readable numeric code that can be loaded into, and directly executed by, a computer. As described below, the C++ language has certain characteristics which allow a software developer to easily use programs written by others while still providing a great deal of control over the reuse of programs to prevent their destruction or improper use. The C++ language is well-known and many articles and texts are available which describe the language in detail. In addition, C++ compilers are commercially available from several vendors including Borland International, Inc. and Microsoft Corporation. Accordingly, for reasons of clarity, the details of the C++ language and the operation of the C++ compiler will not be discussed further in detail herein.

As will be understood by those skilled in the art, Object-Oriented Programming (OOP) techniques involve the definition, creation, use and destruction of “objects”. These objects are software entities comprising data elements, or attributes, and methods, or functions, which manipulate the data elements. The attributes and related methods are treated by the software as an entity and can be created, used and deleted as if they were a single item. Together, the attributes and methods enable objects to model virtually any real-world entity in terms of its characteristics, which can be represented by the data elements, and its behavior, which can be represented by its data manipulation functions. Objects are defined by creating “classes” which are not objects themselves, but which act as templates that instruct the compiler how to construct the actual object. A class may, for example, specify the number and type of data variables and the steps involved in the methods which manipulate the data. When an object-oriented program is compiled, the class code is compiled into the program, but no objects exist. Therefore, none of the variables or data structures in the compiled program exist or have any memory allotted to them. An object is actually created by the program at runtime by means of a special function called a constructor which uses the corresponding class definition and additional information, such as arguments provided during object creation, to construct the object. Likewise objects are destroyed by a special function called a destructor. Objects may be used by using their data and invoking their functions. When an object is created at runtime memory is allotted and data structures are created.

Network Environment

The illustrative embodiment of the invention may be implemented as part of Lotus Notes® and a Lotus Domino server, both commercially available from International Business Machines Corporation, Armonk, N.Y., however it will be understood by those reasonably skilled in the arts that the inventive functionality may be integrated into other applications as well as the computer operating system.

The Notes architecture is built on the premise of databases and replication thereof. A Notes database, referred to hereafter as simply a “database”, acts as a container in which data Notes and design Notes may be grouped. Data Notes typically comprises user defined documents and data. Design Notes typically comprise application elements such as code or logic that make applications function. In Notes, every database has a master copy which typically resides on the server or user platform where the database was created. All other copies of the database are replicas of the master copy. Replicas of databases may be located remotely over a wide area network, which may include as a portion thereof one or more local area networks. In the illustrative every object within a Notes database, is identifiable with a unique identifier, referred to hereinafter as “Note ID”, as explained hereinafter in greater detail.

A “document” as used herein may refer to a document, database, electronic mail message code, a “Note” or any file which is accessible and storable by a computer system. The Notes Storage Facility (NSF) architecture defines the manner in which documents and databases are created, modified and replicated among Notes servers across a computer network. Information regarding the Notes Storage Facility and its specification is available from International Business Machines Corporation, Armonk, N.Y., as well as on-line at www.Notes.net.

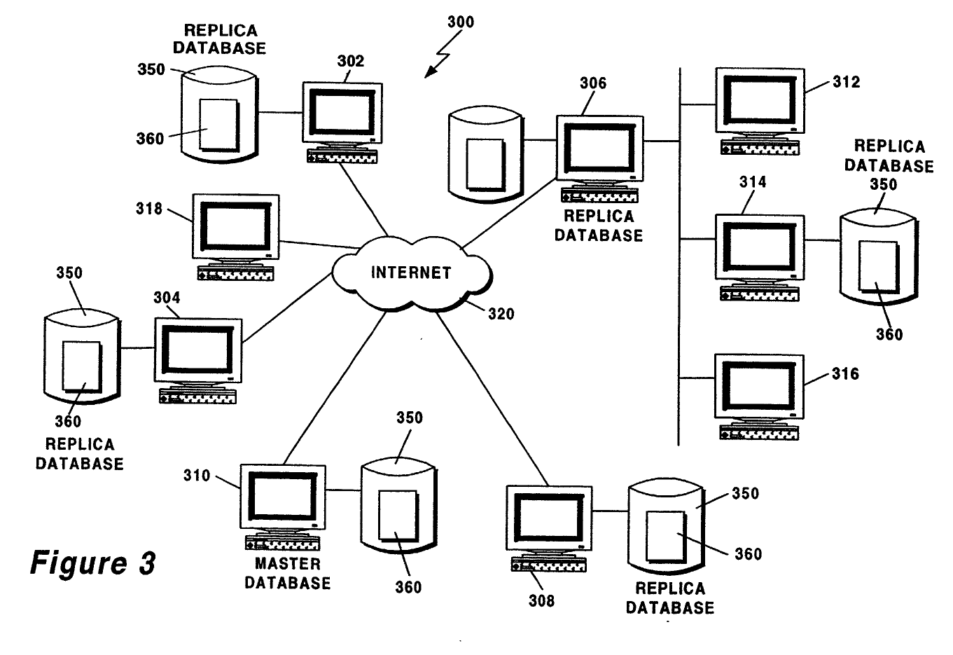

FIG. 3 illustrates a network environment in which the invention may be practiced, such environment being for exemplary purposes only and not to be considered limiting. Specifically, a packet-switched data network 300 comprises servers 302-310, a plurality of Notes processes 310-316 and a global network topology 320, illustrated conceptually as a cloud. One or more of the elements coupled to global network topology 320 may be connected directly or through Internet service providers, such as America On Line, Microsoft Network, Compuserve, etc. As illustrated, one or more Notes process platforms may be located on a Local Area Network coupled to the Wide Area Network through one of the servers.

Servers 302-308 may be implemented as part of an all software application which executes on a computer architecture similar to that described with reference to FIG. 1. Any of the servers may interface with global network 320 over a dedicated connection, such as a T1, T2, or T3 connection. The Notes client processes 312, 314, 316 and 318, which include mail functionality, may likewise be implemented as part of an all software application that run on a computer system similar to that described with reference to FIG. 1, or other architecture whether implemented as a personal computer or other data processing system. As illustrated conceptually in FIG. 3, servers 302-310 and Notes client process 314 may include in memory a copy of database 350 which contains document 360. For purposes of illustration, the copy of database 350 associated with server 310 is designated as the “master” copy of database 350. All other copies of database 350 within the network are replica copies of the master copy.

Shadow Document Generation

To implement the primary functionality of the present invention in a Lotus Notes environment, a module, referred to hereafter as Notes Mail Agent 230 interacts with the existing functionality, routines or commands of Lotus Notes client application and/or a Lotus “Domino” server, many of which are publicly available. The Lotus Notes client application, referred to hereafter as application 220, executes under the control of operating system 210 which in turn executes within the hardware parameters of hardware platform 200. Hardware platform 200 may be similar to that described with reference to FIG. 1. Mail Agent 230 interacts with application 220 and with one or more documents 260 in databases 250. The functionality of Mail Agent 230 and its interaction with application 220 and databases 250 is described hereafter. In the illustrative embodiment, module 230 may be implemented in an object-oriented programming language such as C++. Accordingly, the data structures and functionality may be implemented with objects displayable by application 220 may be objects or groups of objects. In light of the description herein, the construction and function of module 230 is within the scope of understanding of those reasonably skilled in the arts.

Mail Agent 230 comprises a parser 232, a shadow document generator 234 and a conversation thread tree builder 236. The primary function of Notes Mail Agent 230 is to create a shadow document from an original document, which, in the illustrative embodiment, is an electronic mail message. Typically, this process is triggered by an occurrence of an event. In the first illustrative embodiment, Mail Agent module 230 may be invoked upon the sending of an electronic mail message by a Lotus Notes client application. In this instance, Agent 230 may reside within the Lotus Notes client, as illustrated in FIG. 2 or on the same system. Simultaneously, a Lotus Notes Mail Agent 230 may execute on a Lotus Notes “Domino” server and function to create a shadow document for each document or electronic message transmitted from other non-Notes processes prior to delivery to a recipient Notes process. The shadow documents are generated transparently to the actual user sending or receiving the electronic message. Alternatively, in a second illustrative embodiment, described herein Mail Agent 230 may be invoked upon the receipt of a request to delete an original document or electronic mail message.

Mail Agent 230 creates a shadow document from an original document by generating a file containing data related to the document. In the illustrative embodiment, shadow documents are stored as documents in a Lotus Notes database and are accessible via the Notes Storage Facility (NSF) Application Program Interfaces. Specifically, shadow documents are stored in a Notes mail database. The data maintained in a shadow document defines the parent/child relationships among original documents and their respective shadow documents. In the illustrative embodiment, a new electronic mail message is considered a parent document and serves as the root from which a new shadow tree may be derived, as explained hereinafter. Any replies to the original electronic mail message is/are considered a child/children document(s). Within a conversation thread, and a hierarchical tree that represents such thread, children documents derive from a common root document. Accordingly, a parent/child tree hierarchy representing a conversation thread terminates at one extreme with a root document, or a shadow document thereof, and, at the other extreme, with one or more children documents, or shadows thereof, as the leaves of the tree.

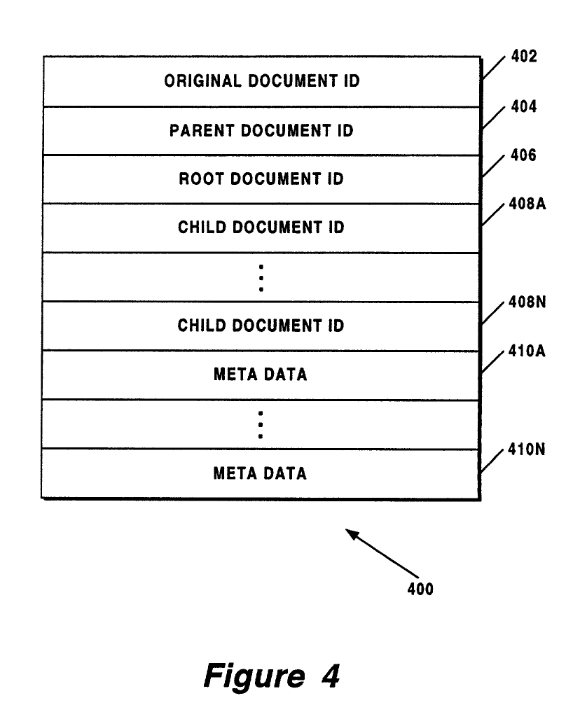

FIG. 4 illustrates conceptually the structure and content of a shadow document 400 in accordance with the present invention. As shown, shadow document 400 comprises an Original Document Identified (ID) 402, a Parent Document ID 404, an optional Root Document ID 406, zero or more Child Document IDs 408a-n, and optional Meta Data fields 410a-n. Original Document ID 402 may comprise a pointer to the original document, e.g. an electronic mail message, which may no longer exist in the database. Parent Document ID 404 may comprise a pointer to the immediate parent document, whether a shadow or original document, in the tree hierarchy Parent Document ID 404 may have a null value if the subject document is the root of the conversation thread tree. Optional Root Document ID 406 may comprise a pointer to the root of the conversation thread tree, whether shadow or original. Root Document ID 406 allows for efficiency in traversing the tree hierarchy. Child Document IDs 408a-n may comprise a list of pointers to the immediate children documents, whether shadow or original, in the tree hierarchy, if any. In the illustrative embodiment the value of Ids 402-408 may be the Notes ID value for a document. Additionally, Meta Data fields 410a-n may comprise meta data describing the original electronic message documents and/or any attachments thereto.

In the illustrative embodiment, the meta data may include such logistical information as sender, receiver, original size, subject, date, any carbon copy recipients, etc. associated with the document. In addition, key words or summaries of the content of the document or any attachments may likewise be included. Such functionality may be performed by Mail Agent 230 with calls to commercially available products such as Intelligent Miner for Text from IBM Corporation, Armonk, N.Y., or KeyView from Verity, Sunnyvale, Calif., which then parse and filter the content to find key words or create summaries.

At the time a document, particularly an electronic message is generated, shadow document generator 234 includes code routines or objects, which, upon invocation sets up a shadow document and identifies any parent and/or child documents of the subject document and, optionally, further identifies the root document of a conversation-thread tree to which the subject document is a member. A similar process is performed by the shadow document generator 234 of a Mail Agent 230 executing on a Domino server. Parser 232 includes code routines or objects, which, upon invocation sets up a shadow document and parses the original document and any header of the following data fields: sender, receiver, original size, subject, date, any carbon copy receivers, attachment names, etc. and makes call to filtering software modules, as necessary. A shadow file is stored in an electronic mail database which may then be replicated in the manner previously described in the Notes environment.

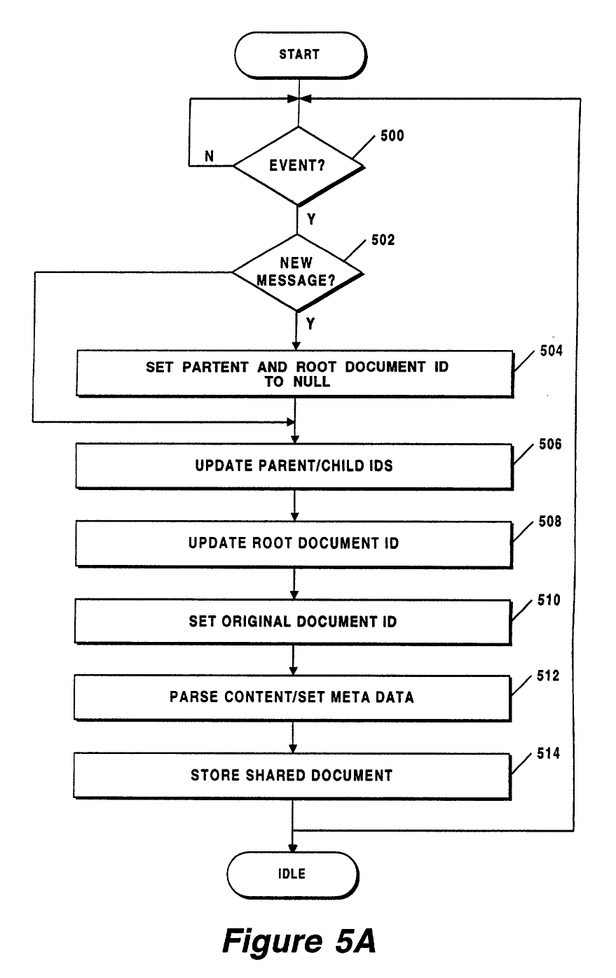

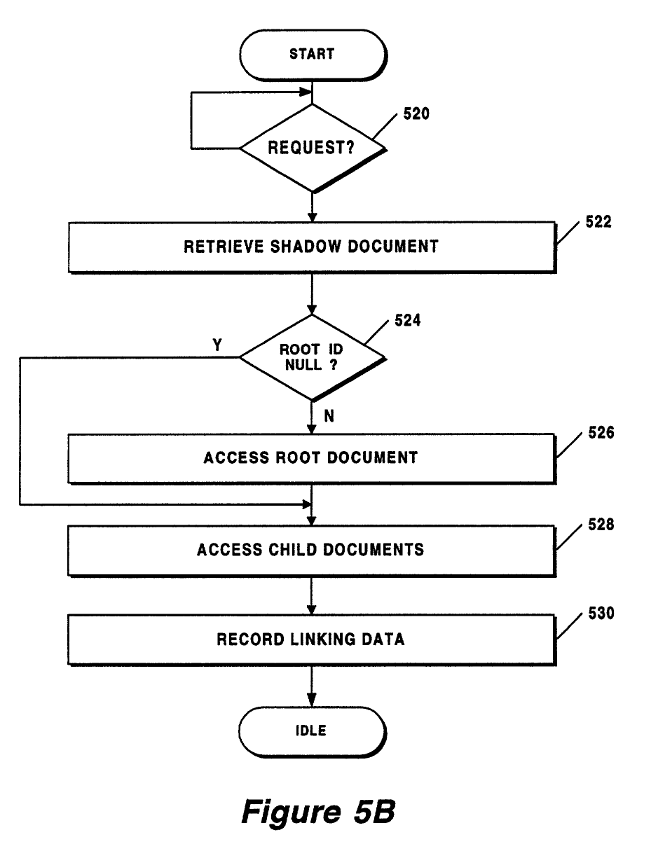

FIGS. 5A and B are flow charts illustrating the process steps performed by parser 232 and shadow document generator 234 during the present invention. As illustrated in FIG. 5A, Mail Agent 230 first detects the occurrence of a triggering event as illustrated by decisional step 500. Such event may include the sending or receipt of an electronic message, or, alternatively a request to delete an electronic message. Next, Mail Agent 230 determines if the electronic message is a new message, as illustrated by decisional step 502. Within a Lotus Notes electronic mail domain, it is possible to determine with existing object methods to which message an incoming message is a reply. If the incoming message is from the Internet or from a non-Notes environment, a conventional algorithm can be used to determine if the message is a new message or a reply to an existing message by determining if the message has an “In-Reply-To” header, or whether the subject lines of the message match an existing message or shadow document. If so, Root Document ID 406 and Parent Document ID 404 are both set to null, as illustrated by procedural step 504. Otherwise, Mail Agent 230 sets the Parent Document ID 404 to a pointer value referencing the parent document and simultaneously modifies one of the Child Document IDs 408a-n of the parent document to reference the subject shadow document, as illustrated by procedural step 506. Additionally, Mail Agent 230 sets Root Document ID 406 to reference the root of the conversation thread tree, as illustrated by procedural step 508. Mail Agent 230 then sets the Original Document ID 402 to reference the original document from which the shadow document was created, as illustrated by procedural step 510. If the original document has been deleted, the value of Original Document ID 402 is set to null. Finally, Parser 232 parses the header information of the original electronic message for meta data and populates Meta Data fields 410a-n accordingly, as illustrated by procedural step 512. Parser 232 may optionally make procedure calls for scanning of the document content or any of its attachment for key words or phrases to be saved as meta data. Thereafter, the shadow document is stored in memory, which, in the illustrative embodiment, is a mail database, as illustrated by procedural step 514.

The above-described process is substantially the same whether the Mail Agent 230 resides in the Notes client or a Domino server in a Notes environment. In addition, if the triggering event in step 500 was a request for deletion of an original document, instead of pointing only to other shadow documents, the pointer values of the IDs 404-408 within shadow document 400 may also reference other original documents as well. In this embodiment, shadow documents serve as placeholders for missing original documents in the original conversation thread hierarchy.

Given the content of shadow documents and their relationship to the original or root document, an algorithm in Tree Builder 236 can be used to traverse the chain of pointers or references to the parent of each shadow document, and, once the root has been identified, to then recursively traverse all references to each child document within the conversation thread. In this manner, a complete tree representing the conversation thread may be determined from the data collected by Tree Builder 236. The data identifying the documents or nodes of the tree, can then provided to program code which may visually render the tree for the users benefit, as discussed in greater detail herein.

Referring to FIG. 5B, the process steps performed by conversation thread Tree Builder 236 is illustrated. Initially, Tree Builder 236 receives a request to construct a conversation thread tree, as illustrated by decisional step 520. Such request may be triggered by any number of different events including selection of a specific command within the Notes client application 220, automatically upon entering the mail function of the Notes client, or upon selection of an electronic message from a mail viewer utility. Tree Builder 236 receives the identifier of a document, typically a Notes ID, and retrieves the corresponding shadow document data from the mail database, as illustrated by procedural step 522. Next, Tree Builder 236 examines the Root Document ID field of the accessed shadow document and determines if the field contains a null value, indicating that the subject document is a root document, as illustrated by decisional step 524. If the value of the Root Document ID field is not null, Tree Builder 236 retrieves the document identified by the pointer within the Root Document ID field, whether a shadow or original document, and records the document identifier and pointer value in a tree data document or database, as illustrated by procedural step 526. Next, Tree Builder 236 resolves the child document IDs 408a-n in the document identified by the pointer within the Root Document ID field, i.e. the root document, as well as each of their respective child documents, in a recursive manner, as will be understood by those reasonably skilled in the arts, until the Child Document ID fields in all child documents are null, indicating that the leaf nodes within the conversation thread tree have been identified, as illustrated by steps 528. As will be understood by those reasonably skilled in the arts, any number of known algorithms for iteratively traversing data values linked in a hierarchical manner may be utilized in step 528 to resolve the references to child documents from a parent document until no further child document exists, indicating a leaf node in the conversation thread have been identified. Tree Builder 236 progressively records the document IDs in the tree document or database during the resolution process and, upon completion, stores such tree document or database in memory, as illustrated by steps 530.

In an alternative implementation, since a large number of electronic mail documents are received, a large number of shadow documents will be generated. To reduce memory requirements, while still providing the functionality of the invention, the data from all shadow documents within a conversation thread may be stored in a single tree document within a Lotus Notes database, instead of multiple documents. In such embodiment, a single tree document will include all of the meta and linking data of the individual nodes within the conversation thread tree and may be kept in the database using XML format or other markup language utilizing tags.

Visualization

With complete message thread information using the techniques described herein, visualization of conversation thread trees is possible. Since conversation thread trees, from observations, are not very deep nor very bushy in general, a simple graphical representation of the message thread and highlighting of the interesting relationships among the parties involved in the conversation is possible. The tree data compiled by generator 236 may then be provided to a graphics program for visually rendering a conceptual representation of a conversation thread tree. For example, the existing DiscussionsThreadsView functionality within Notes can be used to construct and display a complete conversation thread.

In the illustrative embodiment, we are using Lotus Domino for the underlying object store. The user interface may be developed using IBM Sash, a development environment based upon dynamic HTML and JavaScript. Alternatively, a JAVA applet running in a portion of the Notes client gets the Notes document data representing the tree Notes from the data base and renders the tree graphically. Notes may be rendered with different graphic elements such as color to define relationships. By selecting one of the nodes in a tree by user can, in one embodiment, cause a low resolution display of that document, either the original or the shadow document, to be displayed within the context of the tree.

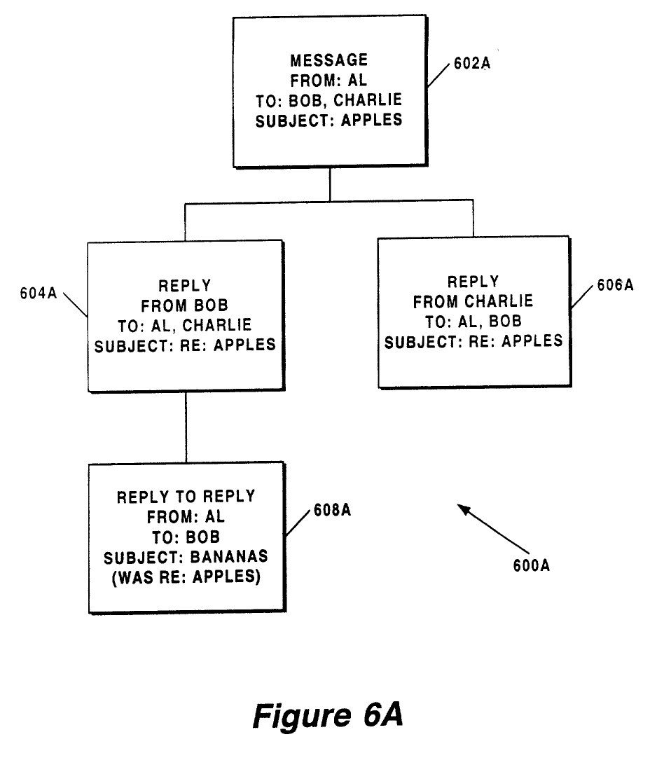

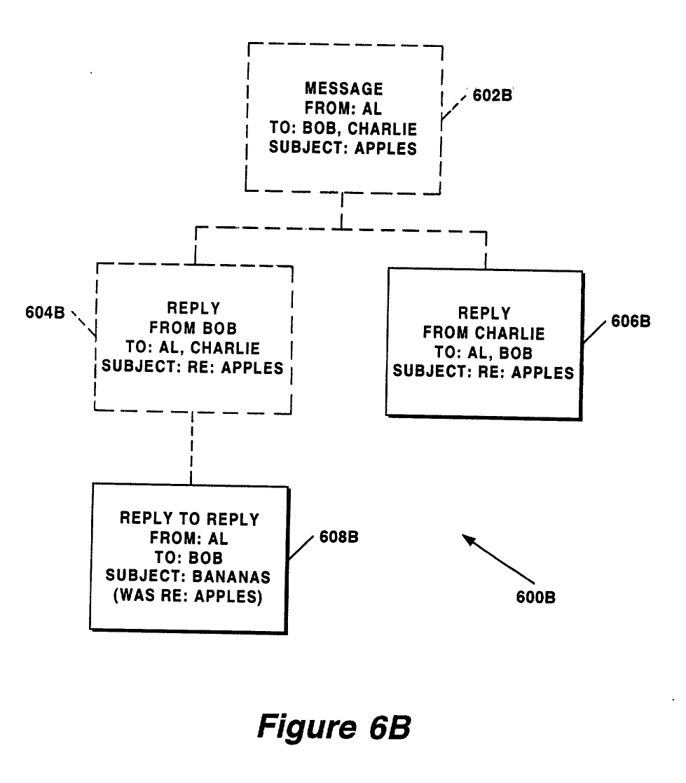

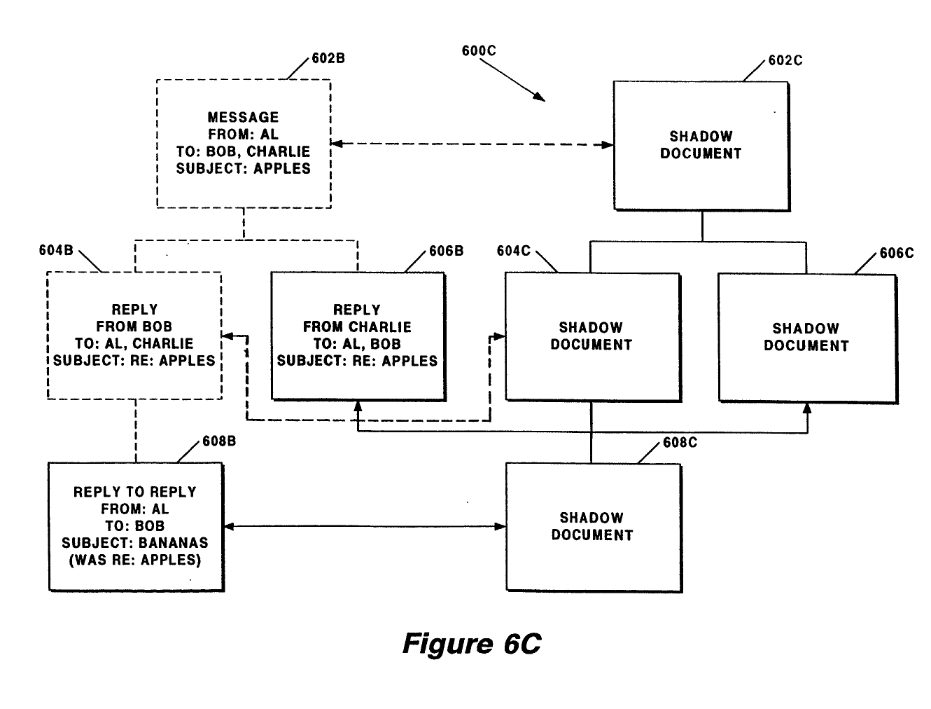

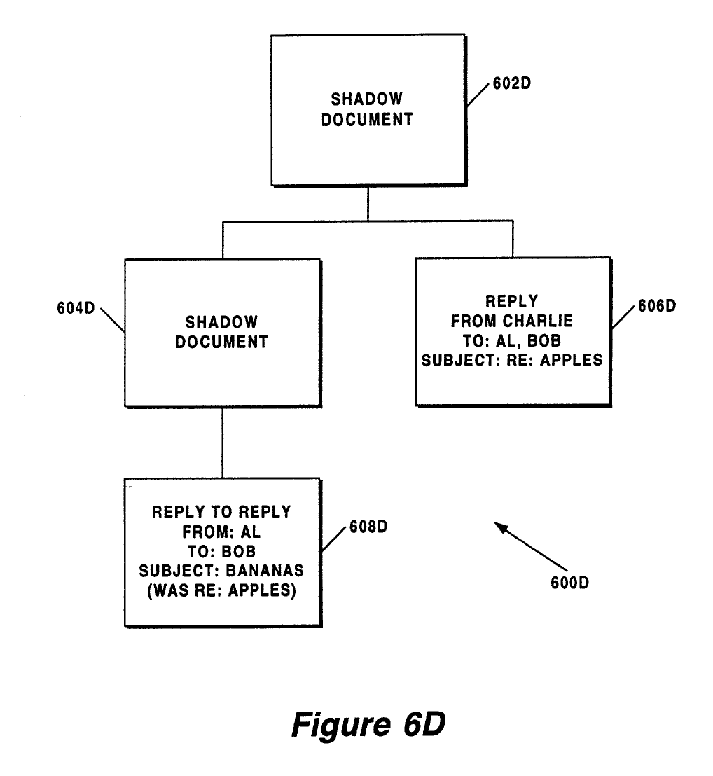

FIGS. 6A-D illustrate a conversation thread in the form of a document trees 600A-D. In FIG. 6A, tree 600A represents an original conversation thread in which an electronic message from Al to Bob and Charlie serves as the root document 602A of the tree 600A. Documents 604A, 606A, and 608A are replies or replies to replies and therefore child documents of parent/root document 602A. For the sake of illustration, assume that documents 602A and 604A are deleted by user Bob, resulting in the conversation thread tree 600B as illustrated in FIG. 6B. In FIG. 6B, documents 602B and 604B are shown in phantom, indicating that the original document has been deleted. With the present invention, a shadow tree 600C was created comprising documents 602C-608C, which are the shadow documents of documents 602A-608A, respectively. The relationship of shadow tree 600C and the original conversation thread tree 600A is illustrated in FIG. 6C. The shadow tree 600C remains in tact and may be constructed and viewed as necessary despite original documents 602A and 604A having been deleted. In an embodiment in which shadow documents are created upon a request to delete the original document, such as that illustrated in FIG. 6D, the conversation thread tree 600D is a hybrid tree consisting of shadow documents 602C-604C and original documents 606D and 608D.

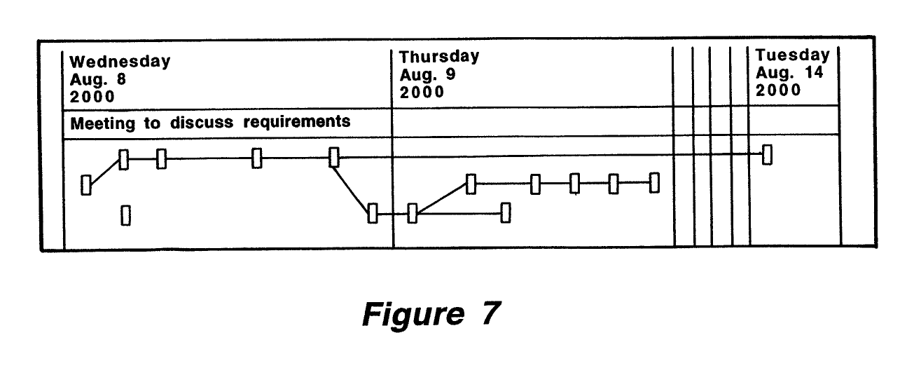

One attribute of electronic mail that is valuable to visualize is the time when a message was received. The present invention combines the message trees described above with a timeline to produce a more useful visualization. FIG. 7 illustrates a design for displaying a message tree 702 on a timeline 700. In FIG. 7, the vertical lines represent day boundaries. The text in the middle band is the subject of the thread. The nodes may be color-coded to indicate the relationship of the message senders to the recipient. Note that time is non-linear in this display; days with little or no activity are shown compressed to avoid the problem of large gaps in the time display. For example, a timeline can be broken to show a large passage of time. This might be useful if electronic mail is received from someone infrequently. In that case, the system could show on the timeline the most recent threads of conversation with that person. Also, information from people's calendars may be incorporated to aid in search. For example, a user might remember that he/she received a certain piece of mail just before going for vacation last summer. By incorporating these “milestones” on the timeline view the information can be found more easily. The present invention places message nodes proportionally within a day even though the width of a day on the timeline may vary.

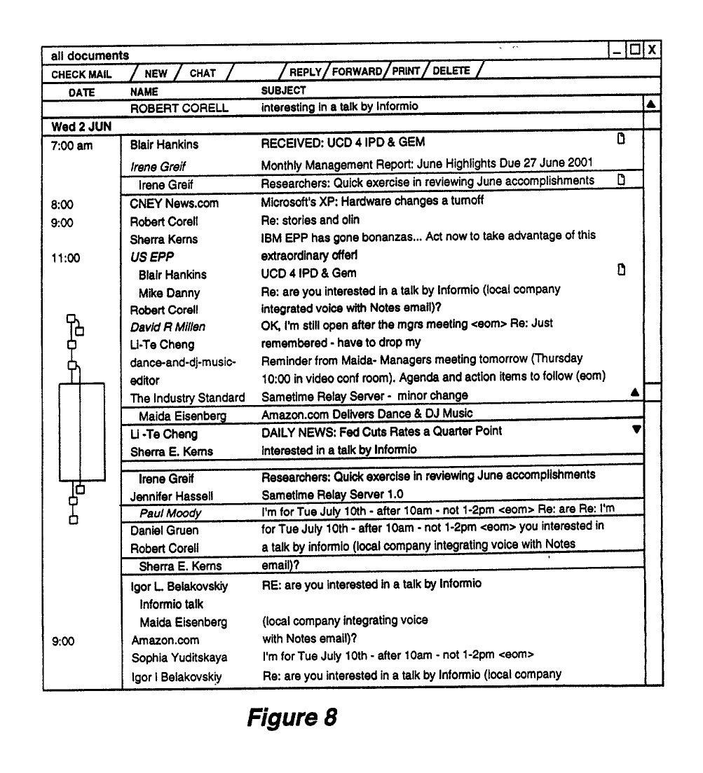

The user interface 800 of an electronic mail client in accordance with the invention may have the format shown in FIG. 8. The user interface combines a traditional list of electronic mail messages 802 with a conversation tree 804. The node associated with the selected message 806 may be replaced with a reduced-resolution overview 808. A dimmer, secondary highlight or other graphic indicia may be used to highlight messages within list 802 which are also displayed in the conversation-thread tree 804.

A software implementation of the above-described embodiments may comprise a series of computer instructions either fixed on a tangible medium, such as a computer readable media, e.g. diskette 142, CD-ROM 147, ROM 115, or fixed disk 152 of FIG. 1A, or transmittable to a computer system, via a modem or other interface device, such as communications adapter 190 connected to the network 195 over a medium 191. Medium 191 can be either a tangible medium, including but not limited to techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. Further, many of the system components described herein have been described using products from International Business Machines Corporation, Armonk, N.Y. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results. Such modifications to the inventive concept are intended to be covered by the appended claims.

What is claimed is:

1. In a computer system operatively coupled to a network and capable of executing a communication process for sending and receiving electronic mail documents, a method comprising:
(A) creating a shadow document from an original document;
(B) identifying one of a parent and child document of the original document and storing a reference thereto in the shadow document; and
(C) storing the shadow document in memory.

2. The method of claim 1 wherein (A) further comprises:
(A1) parsing the original document for selected of the logistical data.

3. The method of claim 2 wherein the logistical data comprises any of sender, a receiver, original size, subject, date, carbon copies of the original document.

4. The method of claim 1 wherein (A) further comprises:
(A1) filtering the original document for selected content.

5. The method of claim 2 wherein the shadow document further comprises selected data from the content of the original document.

6. The method of claim 1 wherein the shadow document is created upon transmission of an original document to the communication process.

7. The method of claim 1 wherein the shadow document is created upon the sending of an original document by the communication process.

8. The method of claim 1 wherein the shadow document is created upon the receipt of a request to delete the original document by the communication process.

9. The method of claim 1 wherein a shadow document for an electronic mail message further comprises a reference to one of the original content and original attachments of the electronic mail message.

10. A computer program product for use with a computer system operatively coupled to a network and capable of executing a communication process for sending and receiving electronic mail documents, the computer program product comprising a computer useable medium having embodied therein program code comprising:
(A) program code for creating a shadow document from an original document;
(B) program code for identifying one of a parent and child document of the original document; and
(C) program code for storing the shadow document in memory.

11. A computer data signal embodied in a carrier wave for use with a computer system operatively coupled to a network and capable of executing a communication process for sending and receiving electronic mail documents, the computer data signal comprising:
(A) program code for creating a shadow document from an original document;
(B) program code for identifying one of a parent and child document of the original document; and
(C) program code for storing the shadow document in memory.

12. An apparatus for use with a computer system operatively coupled to a network and capable of executing a communication process for sending and receiving electronic mail documents, the apparatus comprising:
(A) program logic for creating a shadow document from an original document;
(B) program logic for identifying one of a parent and child document of the original document; and
(C) program logic for storing the shadow document in memory.

13. The method of claim 1 further comprising:
(D) presenting graphical representations of a plurality of documents in a manner which indicates relationships among the documents.

14. The method of claim 13 wherein at least one of the plurality of presented documents is an original document.

15. The method of claim 13 wherein at least one of the plurality of presented documents is a shadow document.

16. The method of claim 1 further comprising:
(E) resolving the reference in a shadow document to one of the parent and child document; and
(F) maintaining in memory data identifying a plurality of shadow documents and any parent and child documents thereof.

17. The method of claim 13 wherein (D) comprises:
(D1) presenting the organized plurality of shadow documents with graphical representations in a parallel tree arrangement.

18. In a computer system operatively coupled to a network and capable of executing a communication process for sending and receiving electronic mail documents, a method comprising:
(A) creating a shadow document from an original document upon sending of the original document by the communication process;
(B) identifying one of a parent and child document of the sent original document and storing a reference thereto in the shadow document;
(C) creating a shadow document from an original document received from another communication process;
(D) identifying one of a parent and child document of the received original document and storing a reference thereto in the shadow document; and
(E) storing the shadow documents in memory.

19. The method of claim 18 further comprising:
(F) resolving the reference in a shadow document to one of the parent and child document; and
(G) maintaining data identifying a plurality of shadow documents and any references to any parent and child documents thereof.

20. The method of claim 18 further comprising:
(H) presenting graphical representations of a plurality of documents in a manner which indicates relationships among the documents.
